(19) United States
(12) Patent Application Publication
(10) Pub. No.: US 2014/0125608 A1
(43) Pub. Date: May 8, 2014

(54) TABLET DEVICE AND TACTILE PRESENTATION METHOD

(71) Applicant: Kazuhito Murata, Tokyo (JP)

(72) Inventor: Kazuhito Murata, Tokyo (JP)

(73) Assignee: NEC CORPORATION, Minato-ku, Tokyo (JP)

(21) Appl. No.: 13/977,961

(22) PCT Filed: Jan. 6, 2012
(86) PCT No.: PCT/JP2012/050188

§ 371 Date: Sep. 16, 2013

(30) Foreign Application Priority Data
Jan. 7, 2011 (JP) 2011-001821
Jul. 28, 2011 (JP) 2011-165231

(51) Int. Cl. G06F 3/01; G06F 3/041

(52) U.S. Cl. CPC G06F 3/016; G06F 3/041
USPC 345/173

(57) ABSTRACT

A tablet device includes: a pressing operation unit that receives a pressing operation from an indicator; and a controller that detects a pressing position of the indicator with respect to the pressing operation unit. The pressing operation unit includes: a housing; a partition wall that partitions an inner space of the housing into a plurality; an elastic sheet that is disposed over an upper portion of the partition wall so as to cover the plurality of spaces partitioned by the partition wall, the elastic sheet elastically deforming in a direction orthogonal to a surface thereof; a pressure-sensitive sheet which is laminated over the elastic sheet, the pressure-sensitive sheet outputting as pressing position information a position pressed by the indicator; a sensor that is provided over the partition wall, the sensor outputting as indicator position information a position of the indicator over the partition wall upon the indicator being positioned over the partition wall; an actuator that deforms the elastic sheet; and an incompressible fluid that is filled in the spaces enclosed by the housing, the partition wall, and the elastic sheet. The controller controls actuation of the actuator based on the pressing position information and the indicator position information.

### TECHNICAL FIELD

The present invention relates to a tablet device and a tactile presentation method.

### BACKGROUND ART

A tablet device, when an indicator such as a stylus pen or a finger is brought into contact with or brought close to its operation panel, detects the input operation position on the operation panel, and outputs that input operation position data to a processing device such as a personal computer.

In this kind of tablet device, when the user performs an input operation with the indicator, it is preferable for an operational feeling to be imparted to the user.

Therefore, for example, in the tablet device described in Patent Document 1, when an input operation is detected, the operation panel or support substrate is made to vibrate by a piezoelectric vibrator. By this constitution, an operational feeling is imparted via the stylus pen or finger that is in contact with the operation panel.

Patent Document 2 discloses a surface material for a pen input device that is used by being affixed to the operation surface of a tablet device, and that has good restorability and an excellent writing feeling.

Patent Document 3 discloses a surface material for a pen input device that is used by being affixed to the operation surface of a tablet device in the same manner as Patent Document 2, that has a good writing feeling during pen input and that has excellent durability.

Patent Document 4 discloses an operation device in which a top plate is fixed on the upper surface of an actuator on a base plate via a column support, and a nonvolatile display sheet having a hole which penetrates through a column support is provided between the actuator and the top plate. In this operation device, by applying a driving current to the actuator of an operation key, the actuator expands to push up the top plate via the column support. Then, when the top plate is depressed, the depression of the operation key is detected from a change in the voltage applied to the actuator. In this way, an operational feeling is imparted to the user by the operation of pressing down the top plate that has been pushed up.

The touch input device that is disclosed in Patent Document 5 is constituted by a cushion sheet, a planar pressure sensitive sensor, and a flexible touch panel being overlapped on a base plate so as to be in close contact with each other. This touch input device detects an input operation by the pressure sensitive sensor. At this time, by changing the material and thickness of the cushion sheet, it is possible to arbitrarily adjust the pressing feeling.

### PRIOR ART DOCUMENTS

### Patent Documents

[Patent Document 1] Japanese Patent No. 4424729
[Patent Document 2] Japanese Unexamined Patent Application, First Publication No. 2006-119772
[Patent Document 3] Japanese Unexamined Patent Application, First Publication No. 2007-207091
[Patent Document 4] Japanese Unexamined Patent Application, First Publication No. 2010-86500
[Patent Document 5] Japanese Unexamined Patent Application, First Publication No. H05-61592

### SUMMARY OF THE INVENTION

### Problem to be Solved by the Invention

However, the operational feeling that is imparted to the user by a tablet device is ideally the same as the case of writing text or the like on paper with a writing instrument such as a pencil or ball-point pen. There remains substantial room for improvement in providing writing comfort in terms of the proper friction feeling and resistance feeling in accordance with the load and moving speed of the indicator.

An exemplary object of the present invention is to provide a tablet device and a tactile presentation method that can further improve the operational feeling when an input operation is performed by an indicator.

### Means for Solving the Problem

A tablet device according to the present invention includes: a pressing operation unit that receives a pressing operation from an indicator; and a controller that detects a pressing position of the indicator with respect to the pressing operation unit. The pressing operation unit includes: a housing; a partition wall that partitions an inner space of the housing into a plurality; an elastic sheet that is disposed over an upper portion of the partition wall so as to cover the plurality of spaces partitioned by the partition wall, the elastic sheet elastically deforming in a direction orthogonal to a surface thereof; a pressure-sensitive sheet which is laminated over the elastic sheet, the pressure-sensitive sheet outputting as pressing position information a position pressed by the indicator; a sensor that is provided over the partition wall, the sensor outputting as indicator position information a position of the indicator over the partition wall upon the indicator being positioned over the partition wall; an actuator that deforms the elastic sheet; and an incompressible fluid that is filled in the spaces enclosed by the housing, the partition wall, and the elastic sheet. The controller controls actuation of the actuator based on the pressing position information and the indicator position information.

A tactile presentation method of the present invention for providing a tactile sense in a pressing operation from an indicator, includes: preparing a pressing operation unit, the pressing operation unit comprising: a housing; a partition wall partitioning an inner space of the housing into a plurality; an elastic sheet disposed over an upper portion of the partition wall so as to cover the plurality of spaces partitioned by the partition wall; a sensor provided over the partition wall; an actuator deforming the elastic sheet; and an incompressible fluid filled in the spaces enclosed by the housing, the partition wall, and the elastic sheet; detecting as pressing position information a position pressed by the indicator from the pressure-sensitive sheet; detecting from the sensor as indicator position information a position of the indicator over the partition wall upon the indicator being positioned over the partition wall; finding a movement direction of the indicator from sensor position information being already known position information of the sensor, the pressing position information, and the indicator position information; and deforming the actuator in accordance with the movement direction of the indicator, causing the elastic sheet to deform in a direction orthogonal to a surface of the elastic sheet.

### Effect of the Invention

According to the present invention, based on the pressing position information and indicator position information, the actuation of the actuator is controlled and the elastic sheet is deformed. By the pressing of the indicator against this elastic sheet, it is possible to impart a friction feeling and a resistance feeling to the distal end of the indicator. Thereby, it becomes possible to further improve the operational feeling when performing an input operation by the indicator.

### BRIEF DESCRIPTION OF THE DRAWINGS

FIG. 1A is a schematic sectional view along the thickness direction of a tablet device according to a first exemplary embodiment of the present invention.

FIG. 1B is a schematic plan view of the tablet device according to the first exemplary embodiment of the present invention.

FIG. 2A is a sectional view that magnifies a main portion I shown in FIG. 1A.

FIG. 2B is a sectional view that further magnifies the tablet device shown in FIG. 2A.

FIG. 3 is a plan view that shows a situation when moving a stylus pen in the first exemplary embodiment of the present invention.

FIG. 4 is a schematic sectional view that shows a tablet device according to a second exemplary embodiment of the present invention.

FIG. 5 is a schematic sectional view that shows a tablet device according to a third exemplary embodiment of the present invention.

FIG. 6 is a schematic sectional view that shows the tablet device according to the third exemplary embodiment of the present invention.

FIG. 7A is a schematic sectional view that shows a variable pressure member at normal time in the third exemplary embodiment of the present invention.

FIG. 7B is a schematic sectional view that shows the variable pressure member when deformed in the third exemplary embodiment of the present invention.

FIG. 8 is a schematic sectional view that shows a variable pressure member in a fourth exemplary embodiment of the present invention.

FIG. 9 is a schematic sectional view that shows a variable pressure member in a fifth exemplary embodiment of the present invention.

FIG. 10 is a schematic plan view that shows a tablet device according to a sixth exemplary embodiment of the present invention.

FIG. 11 is a schematic sectional view that shows the tablet device according to the sixth exemplary embodiment of the present invention, and shows a cross section along line A-A of FIG. 10.

FIG. 12 is a schematic plan view that shows the case of a graphic to be presented being circular, in the tablet device of the sixth exemplary embodiment of the present invention.

FIG. 13 is a schematic sectional view that shows the case of a control method differing from the case of FIG. 11 in the tablet device of the sixth exemplary embodiment of the present invention.

FIG. 14 is a schematic sectional view that shows the case of a control method differing from the case of FIG. 11 and FIG. 13 in the tablet device of the sixth exemplary embodiment of the present invention.

FIG. 15 is a schematic plan view that shows a tablet device of a seventh exemplary embodiment of the present invention.

FIG. 16 is a schematic sectional view that shows the tablet device of the seventh exemplary embodiment of the present invention, and shows a cross section along line A-A of FIG. 15.

FIG. 17 is a schematic plan view that shows the case of a graphic presented in the tablet device of the seventh exemplary embodiment of the present invention being circular.

FIG. 18 is a schematic plan view that shows a tablet device of an eighth exemplary embodiment of the present invention, and is a schematic plan view that shows the case of presenting a letter.

FIG. 19 is a schematic plan view that shows the tablet device of the eighth exemplary embodiment of the present invention, and is a schematic plan view that shows the case of presenting a numeral.

### EMBODIMENTS FOR CARRYING OUT THE INVENTION

Hereinbelow, tablet devices according to exemplary embodiments of the present invention shall be described, referring to the attached drawings. The present invention is not limited to these exemplary embodiments.

### First Exemplary Embodiment

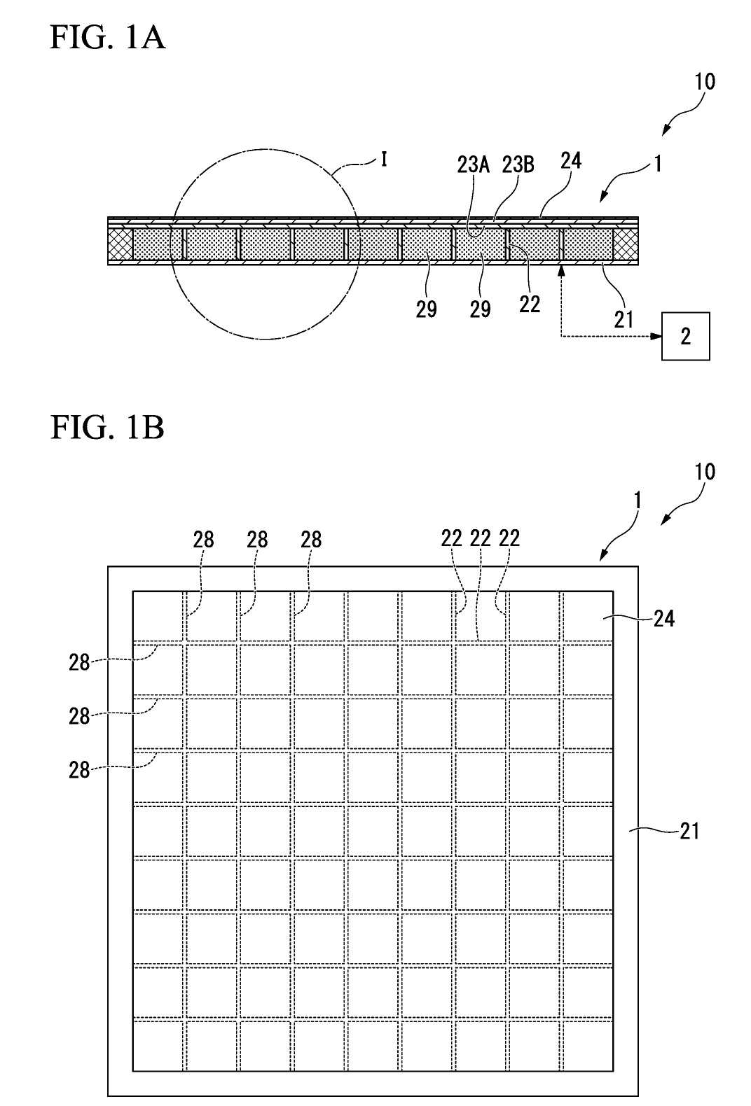

As shown in FIGS. 1A and 1B, a tablet device 10 according to the first exemplary embodiment of the present invention has a pressing operation unit 1 and a controller 2. The pressing operation unit 1 receives a pressing operation from an indicator (a stylus pen in the present exemplary embodiment). The controller 2 detects the pressing position of the indicator with respect to the pressing operation unit 1.

The pressing operation unit 1 includes a housing 21, partition walls 22, an elastic member (elastic sheet) 23A, an elastic member 23B and a pressure-sensitive sheet 24. The partition walls 22 are installed in a standing manner in a lattice shape on the housing 21. The elastic member 23A, the elastic member 23B, and the pressure-sensitive sheet 24 are laminated on the partition walls 22.

The partition walls 22 are fixed by adhesion or the like on the housing 21, and provided at a fixed interval in two mutually perpendicular directions. Thereby, the partition walls 22 are configured in a lattice shape. A plurality of spaces are formed in a matrix shape on the housing 21 by these partition walls 22.

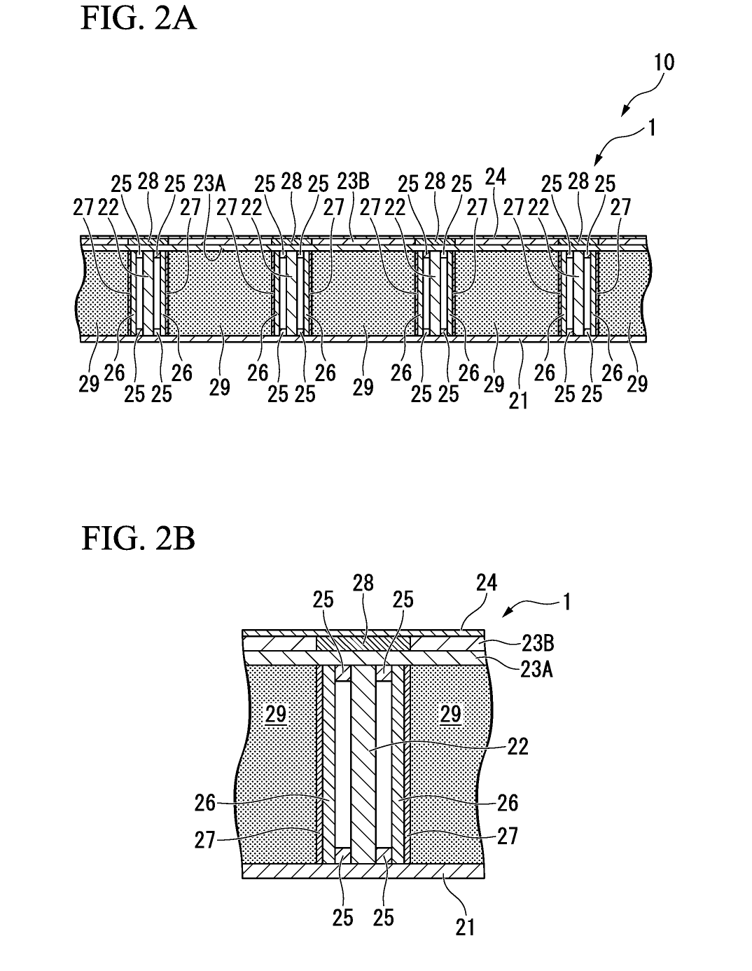

As shown in FIGS. 2A and 2B, an actuator 26 is fixed via a support member 25 to both sides of the partition wall 22. The actuator 26 is supported by the support member 25 at both ends in the height direction of the partition wall 22, respectively. As this actuator 26, a piezoelectric transducer or the like is suitable. A waterproof sheet 27 is affixed by adhesion or the like to the surface of the actuator 26. The actuator 26 is provided on each of the partition walls 22 of the four sides in each space that is partitioned by the partition walls 22.

The elastic member 23A and the elastic member 23B are provided over the partition walls 22. These elastic members 23A and 23B are sheet-shaped. The elastic moduli of the elastic members 23A and 23B may be made to differ with each other.

Sensors 28 are placed on these elastic members 23A and 23B. The sensors 28 are positioned directly above the partition walls 22, and can detect the presence of an object on the sensors 28. As this sensor 28, a photoelectric sensor or the like is suitable. When this sensor 28 detects that the indicator is on the sensor 28, it outputs the position information of the indicator to the controller 2.

The pressure-sensitive sheet 24 is placed and fixed on the elastic member 23B and the sensors 28.

In the case of pressure of a certain value or greater being applied to the pressure-sensitive sheet 24, the pressure-sensitive sheet 24 outputs the position where that pressure has been applied to the controller 2 as pressing position information. The controller 2 of the tablet device 10 determines the position where that pressure is applied on the pressure-sensitive sheet 24 from the pressing position information that has been output.

An incompressible fluid (for example, water) 29 or a gel is filled in each of the spaces that are partitioned in a lattice shape by the partition walls 22 on the housing 21, and enclosed by the housing 21, the actuators 26, and the elastic member 23A.

The operation of the aforementioned tablet device 10 is controlled by the controller 2. When a voltage is applied by the controller 2 to the actuators 26 at the four sides of each space that is partitioned by the partition walls 22, the actuators 26 deform in the direction in which the incompressible fluid 29 of each space is compressed. Then, the pressure in each space increases, and the elastic member 23A and the elastic member 23B bulge, and deform upward in a convex manner.

The control by the controller 2 can be performed by the following flow.

### (Step of Detecting Pressing Position Information)

When the pen tip of a stylus pen, which is the indicator, makes contact with the pressure-sensitive sheet 24, the controller 2 detects the position that is operated by the pen tip of the stylus pen based on the pressing position information that is output from the pressure-sensitive sheet 24.

### (Step of Outputting Indicator Position Information)

Due to the movement of the stylus pen in any direction, the pen tip of the stylus pen arrives over the top of any one of the sensors 28A, 28B, 28C, 28D provided on the perimeter four sides of the space it was positioned immediately before. As a result, due to the switching of the signal that is output from a sensor, the sensor that has detected the touch by the pen tip can be determined by the controller 2 among the sensors 28A, 28B, 28C and 28D that are provided at the perimeter four sides. At this time, the controller 2 knows in advance the positions of the sensors 28A, 2813, 28C, and 28D.

### (Step of Finding the Movement Direction and Moving Speed of the Indicator)

The controller 2 finds the movement direction and moving speed of the touch position of the stylus pen from the pressing position information, which shows the touch position of the stylus pen on the pressure-sensitive sheet 24, and the position of the sensor 28A, 28B, 28C, 28D that has output the indicator position information, which is detected by a signal being switched. The controller 2 has in advance the relation between the time of the signal switchover with the pressing position information and the indicator position information and the moving speed. The controller 2 finds the moving speed from this relation and the time of the signal switchover with the pressing position information and the indicator position information. Alternatively, the controller 2 can also find the moving speed from the time interval of the pressing position information that is input before and after the indicator position information is input, and the distance between the touch positions on the pressure-sensitive sheet 24.

### (Step of Deforming the Elastic Sheet)

The controller 2, in accordance with the movement direction and moving speed that have been found, applies a voltage to the actuator 26 that is ahead in the movement direction to cause it to deform, and thereby deforms the elastic member 23A and the elastic member 23B upward in a convex manner. Thereby, when the stylus pen moves, it is possible to impart a friction feeling and resistance feeling to the pen tip.

By repeating this in turn in the tablet device 10, it is possible to impart a friction feeling and resistance feeling in conjunction with movement of the pen.

A specific example of control by the aforementioned controller 2 shall be given.

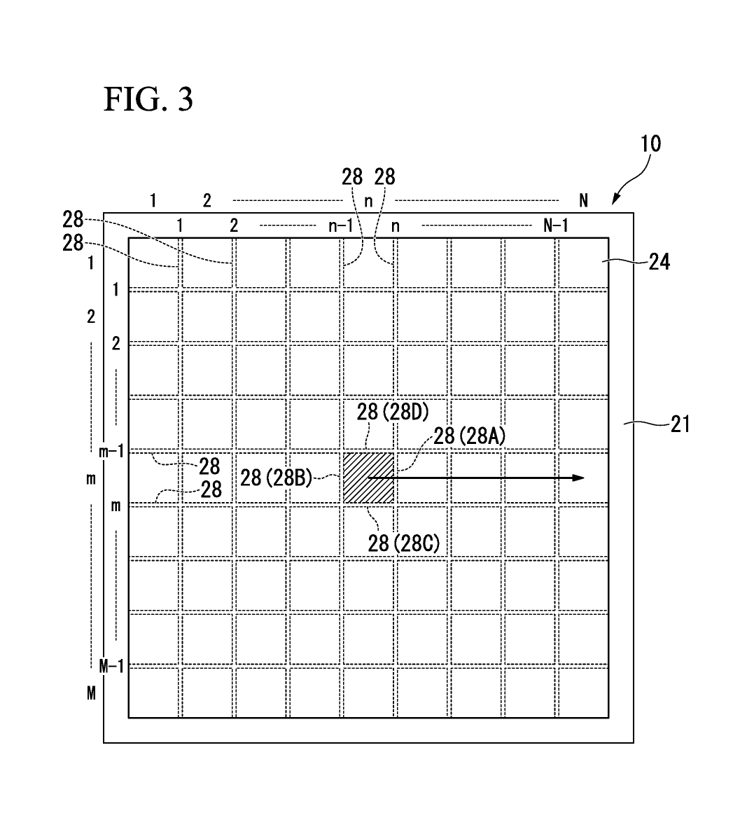

For example, as shown in FIG. 3, in the tablet device 10, there are M in the vertical (in the example of FIG. 3, for example 9) and N in the horizontal (in the example of FIG. 3, for example 9) of the spaces resulting from the housing 21 being partitioned by the partition walls 22. Between adjacent spaces, a total of (M−1) sensors 28 are arranged in the vertical, and a total of (N−1) in the horizontal. In FIG. 3, a position in the vertical direction is defined as a “row” and a position in the horizontal direction is defined as a “column”. As shown in this FIG. 3, in the case of for example the stylus pen (not shown) being at the position of row m and column n indicated by the slated lines, the position that is operated by the stylus pen is recognized by the controller 2 as being “row m, column n” based on the position information that is detected by the pressure-sensitive sheet 24.

In the case of moving the stylus pen rightward from row m, column n (in the direction of the arrow of FIG. 3), the fact that the pen tip of the stylus pen has arrived over the top of the sensor 28A of row m, column n is detected by the controller 2. In response to this detection, the controller 2 applies a voltage to each actuator 26 that is in the space of row m, column (n+1), and thereby the elastic member 23A and the elastic member 23B deform upward in a convex manner.

Thereby, when the stylus pen moves from the position of row m, column n to the position of row m, column (n+1), it is possible to impart a friction feeling and resistance feeling to the pen tip.

By repeating this control in turn, it is possible to impart a friction feeling and resistance feeling in conjunction with movement of the pen in the tablet device 10.

The control in the case of moving the stylus pen in other directions is the same.

In the case of moving the stylus pen leftward, when the pen tip of the stylus pen has arrived over the top of the sensor 28B of column (n−1), the controller 2 applies a voltage to the actuators 26 that are in the space of row m, column (n−1), causing the elastic member 23A and the elastic member 23B to deform upward in a convex manner. Thereby, when the stylus pen moves from the position of row m, column n to the position of row m, column (n−1), it is possible to impart a friction feeling and resistance feeling to the pen tip.

In the case of moving the stylus pen downward, when the pen tip of the stylus pen has arrived over the top of the sensor 28C of row m, the controller 2 applies a voltage to the actuators 26 that are in the space of row (m+1), column n, causing the elastic member 23A and the elastic member 23B to deform upward in a convex manner. Thereby, when the stylus pen moves from the position of row m, column n to the position of row (m+1), column n, it is possible to impart a friction feeling and resistance feeling to the pen tip.

In the case of moving the stylus pen upward, when the pen tip of the stylus pen has arrived over the top of the sensor 28D of row (m−1), the controller 2 applies a voltage to the actuators 26 that are in the space of row (m−1), column n, causing the elastic member 23A and the elastic member 23B to deform upward in a convex manner. Thereby, when the stylus pen moves from the position of row m, column n to the position of row (m−1), column n, it is possible to impart a friction feeling and resistance feeling to the pen tip.

The case of moving the stylus pen in a diagonal direction shall be described.

For example, in the case of moving the stylus pen to the lower right, when the pen tip of the stylus pen has arrived over the top of the sensor 28A of column n, and arrived over the top of the sensor 28C of row m, the controller 2 applies a voltage to the actuators 26 that are in the space of row (m+1), column (n+1), causing the elastic member 23A and the elastic member 23B to deform upward in a convex manner. Thereby, when the stylus pen moves from the position of row m, column n to the position of row (m+1), column (n+1), it is possible to impart a friction feeling and resistance feeling to the pen tip. By repeating this kind of control in turn, it is possible to impart a friction feeling and resistance feeling in conjunction with movement of the pen in the tablet device 10.

In the case of moving the stylus pen to the upper right, when the pen tip of the stylus pen has arrived over the top of the sensor 28A of column n, and arrived over the top of the sensor 28D of row (m−1), the controller 2 applies a voltage to the actuators 26 that are in the space of row (m−1), column (n+1), causing the elastic member 23A and the elastic member 23B to deform upward in a convex manner. Thereby, when the stylus pen moves from the position of row m, column n to the position of row (m−1), column (n+1), it is possible to impart a friction feeling and resistance feeling to the pen tip.

In the case of moving the stylus pen to the lower left, when the pen tip of the stylus pen has arrived over the top of the sensor 28B of column (n−1), and arrived over the top of the sensor 28C of row m, the controller 2 applies a voltage to the actuators 26 that are in the space of row (m+1), column (n−1), causing the elastic member 23A and the elastic member 23B to deform upward in a convex manner. Thereby, when the stylus pen moves from the position of row m, column n to the position of row (m+1), column (n−1), it is possible to impart a friction feeling and resistance feeling to the pen tip.

In the case of moving the stylus pen to the upper left, when the pen tip of the stylus pen has arrived over the top of the sensor 28B of column (n−1), and arrived over the top of the sensor 28D of row (m−1), the controller 2 applies a voltage to the actuators 26 that are in the space of row (m−1), column (n−1), causing the elastic member 23A and the elastic member 23B to deform upward in a convex manner. Thereby, when the stylus pen moves from the position of row m, column n to the position of row (m−1), column (n−1), it is possible to impart a friction feeling and resistance feeling to the pen tip.

As stated above, by detecting the position of the pen tip of the stylus pen to drive the actuators 26, the elastic member 23A and the elastic member 23B are made to bulge and deform upward in a convex manner. By causing the elastic members 23A and 23B to in turn deform upward in a convex manner in accordance with the position of the stylus pen and the movement direction, it is possible to impart a friction feeling and resistance feeling to the pen tip.

At this time, since driving the actuators 26 compresses the incompressible fluid 29 of each space that is touched by the stylus pen, and thereby causes the elastic member 23A and the elastic member 23B to bulge and deform upward in a convex manner, the actuators 26 do not directly press the elastic members 23A and 23B. Due to the incompressible fluid 29 pressing the elastic members 23A and 23B, it is possible to press the entirety of the elastic members 23A and 23B uniformly to cause them to deform.

Moreover, by deforming the elastic members 23A and 23B with the incompressible fluid 29, even in the state of having deformed the elastic members 23A and 23B in a convex manner upward, it is possible to impart a reactive force due to the resilience at the contact surface of the stylus pen. This will lead to a good operational feeling.

At this time, the position of the pen tip of the stylus pen is detected by the pressure-sensitive sheet 24. In the present exemplary embodiment, not only the position of the pen tip, but also the traveling direction and traveling speed of the stylus pen are detected by the sensors 28 that are provided over the partition walls 22. Based on that detection result, the actuators 26 in the space that is ahead in the traveling direction are driven to cause the elastic member 23A and the elastic member 23B of that space to bulge and deform upward in a convex manner.

Here, for example, it is possible to recognize with the controller 2 the traveling direction and traveling speed of the stylus pen by detecting the position of the pen tip of the stylus pen on the pressure-sensitive sheet 24 a plurality of times per micro time. However, with this kind of method, the processing load of the controller 2 is high, and this leads to an increase in power consumption. In contrast to this, according to the constitution of the aforementioned exemplary embodiment, when the stylus pen has arrived over the top of one or two sensors 28 among the four sensors 28 of the four sides of a space, the actuators 26 in the space to the front in the travelling direction of the stylus pen are driven. With this constitution, it is possible to obtain a sufficient effect with a simple process, and the process load in the controller 2 is reduced and it is possible to inhibit the power consumption.

Also, the actuation amount of the actuators 26 can be adjusted by the controller 2. Thereby, it is possible to suitably control the deformation amount of the elastic members 23A and 23B.

In the present exemplary embodiment, the housing 21 and the partition walls 22 are constituted by separate components. However, it is not limited to this constitution. The housing 21 and the partition walls 22 may be constituted by an integral part.

In the present exemplary embodiment, the elastic member 23B with a different elastic modulus is placed on the elastic member 23A, but it is not limited to this constitution. The elastic member 23A and the elastic member 23B may be constituted with an integral part. Moreover, in the present exemplary embodiment, the elastic moduli of the elastic member 23A and the elastic member 23B are made to differ, but it is not limited to this constitution. The elastic moduli of the elastic member 23A and the elastic member 23B may be made the same.

In the aforementioned exemplary embodiment, as shown in FIG. 3, there are formed 81 (=9×9) spaces partitioned by the partition walls 22, but the number of spaces is not limited to this. Also, the vertical and horizontal number are not limited to this.

Hereinbelow, a plurality of other exemplary embodiments of the present invention are shown. In the following, descriptions shall be given centered on the points of difference with the aforementioned first exemplary embodiment, and the same reference symbols shall be given to those constitutions that are in common with the first exemplary embodiment, and descriptions thereof shall be omitted.

### Second Exemplary Embodiment

The point of difference between the second exemplary embodiment and the first exemplary embodiment shall be described. In the first exemplary embodiment, the actuators 26 are fixed to both surfaces of the partition wall 22 in a manner sandwiching the support members 25, while in the second exemplary embodiment, actuators 32 are fixed to the bottom surface of a housing 21 in a manner support members 31 being sandwiched therebetween.

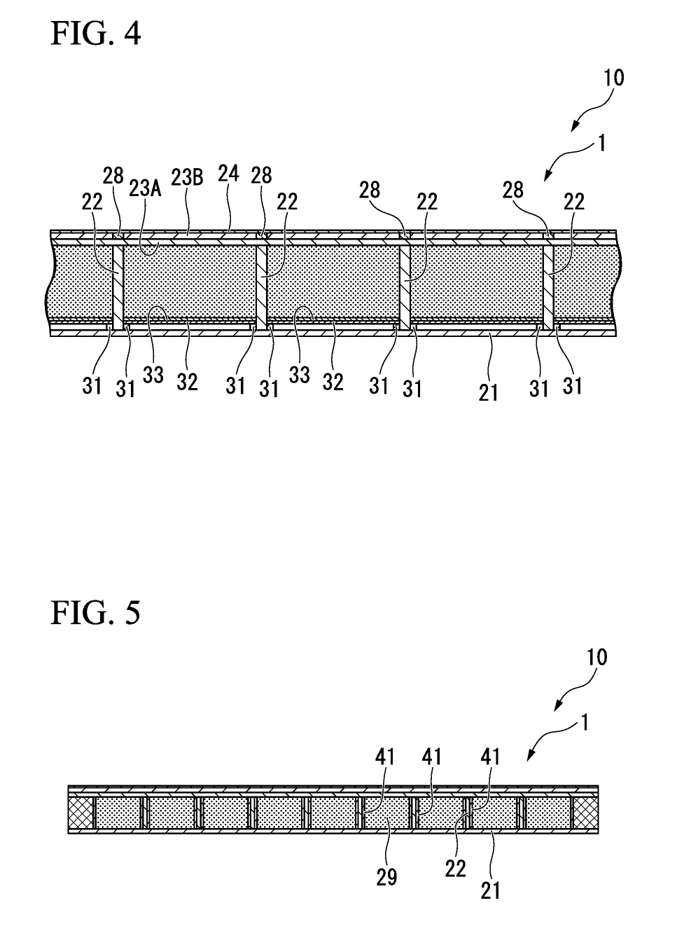

As shown in FIG. 4, the actuators 32, sandwiching the support members 31, are fixed to the bottom surface of the housing 21, in which spaces are partitioned in a lattice shape by the partition walls 22.

Waterproof sheets 33 are affixed by adhesion or the like to the surfaces of the actuators 32.

According to this kind of constitution, when the position and movement direction of the pen tip of the stylus pen are detected by the sensor 28, the controller 2 applies a voltage to the actuator 32, and the actuator 32 is made to deform in a direction in which the incompressible fluid 29 is compressed. Then, when the pressure in the space increases, the elastic member 23A and the elastic member 23B bulge, and are made to deform upward in a convex manner.

With this kind of constitution, in the same manner as the tablet device 10 in the aforementioned first exemplary embodiment, by detecting the position of the pen tip of the stylus pen and driving the actuator 32, the elastic members 23A and 23B are in turn made to deform in a convex manner in accordance with the position and movement direction of the stylus pen, and it is possible to provide a friction feeling and resistance feeling to the pen tip.

### Third Exemplary Embodiment

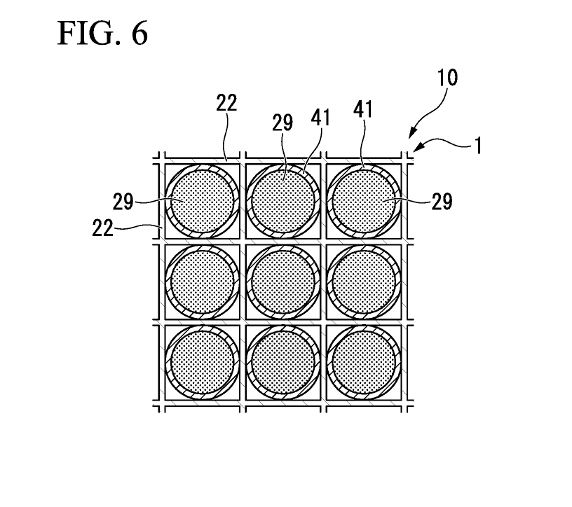

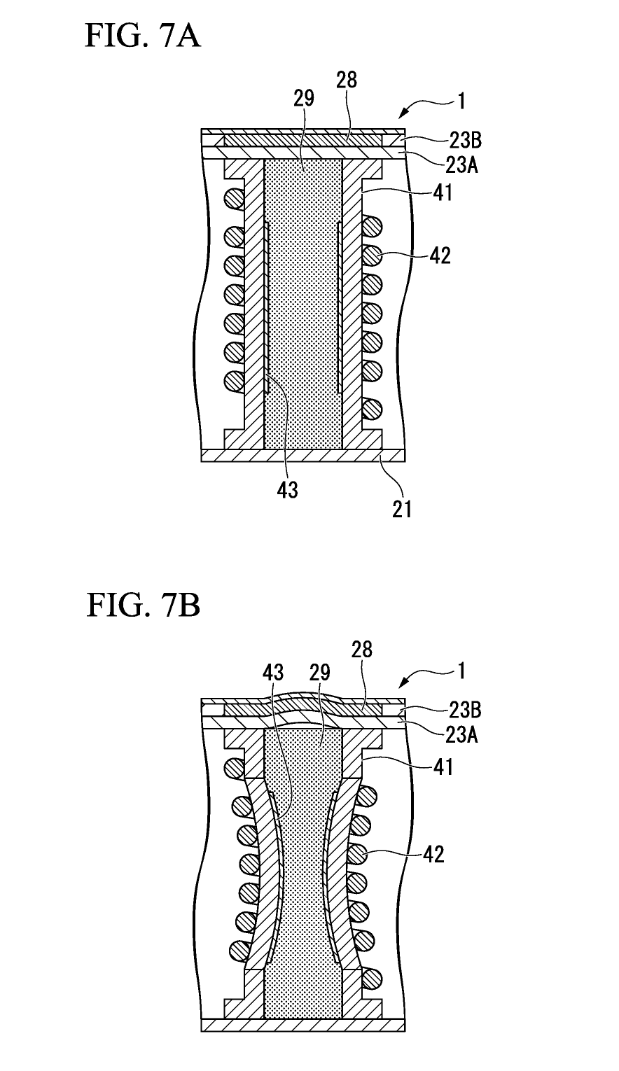

The points of difference between the third exemplary embodiment, and the first exemplary embodiment and the second exemplary embodiment shall be described. The third exemplary embodiment differs from the first and second exemplary embodiments in relation to the method of varying pressure by the actuator to the incompressible fluid that has been sealed. In the first exemplary embodiment, the actuator 26 is fixed via the support member 25 to both surfaces of the partition wall 22 that partitions the housing 21 in a lattice shape, and by applying a voltage, the actuator 26 is made to deform to increase the pressure acting on the incompressible fluid 29, causing the elastic member 23A and the elastic member 23B to deform upward in a convex manner. In the second exemplary embodiment, the actuator 32 is fixed via the support member 31 to the bottom surface of the housing 21, and in the same manner as the first exemplary embodiment, by applying a voltage the actuator 32 is made to deform to increase the pressure acting on the incompressible fluid 29, causing the elastic member 23A and the elastic member 23B to deform upward in a convex manner. In contrast, in the third exemplary embodiment, as shown in FIG. 5, FIG. 6, FIG. 7A and FIG. 7B, a variable pressure member with a hollow cylindrical shape (hollow cylindrical member) 41 is placed in the space on the housing 21 that is partitioned by the partition walls 22, and the incompressible fluid 29 is sealed in the interior of that variable pressure member 41. Changing the volume (shape) of the variable pressure member 41 by the actuator increases the pressure acting on the incompressible fluid 29 to cause the elastic member to deform.

The hollow cylindrical variable pressure member 41 is placed in the space on the housing 21 that is partitioned in a lattice shape by the partition walls 22. The bottom surface of the variable pressure member 41 is fixed by adhesion or the like to the housing 21.

As shown in FIG. 7A and FIG. 7B, a shape memory alloy coil spring (spiral shape memory alloy spring) 42 that is formed so as to elongate or contract due to heat is wound in a spiral shape on the outer wall surface of the variable pressure member 41. A terminal (not shown) is provided at both ends of the shape memory alloy coil spring 42, and constituted so as to be able to apply a voltage. For this kind of shape memory alloy coil spring 42, it is possible to use a material (for example, a Ti—Ni type shape memory alloy) having a characteristic of contracting when the temperature rises, and elongating when the temperature decreases.

A return spring (cylindrical spring) 43 that causes the shape memory alloy coil spring 42 and the variable pressure member 41 to revert to their original shapes when the shape memory alloy coil spring 42 does not possess an expansion force or contraction force due to the heat is fixed to the inner wall surface of the variable pressure member 41.

The incompressible fluid 29 or a gel is sealed in the interior of the variable pressure member 41 with a hollow shape.

In this kind of constitution, when electrical current is passed to the shape memory alloy coil spring 42 via the terminal provided at both ends by the controller 2, it is heated to a high-temperature state and attempts to contract, whereupon the dimension in the length dimension shortens. As a result, the shape memory alloy coil spring 42 produces torsional deformation in the variable pressure member 41. Specifically, the side wall of the variable pressure member 41 sinks in (becomes depressed) in the normal direction with respect to the wall surface of the partition wall 22. At this time, the cross-sectional area of the hollow portion of the variable pressure member 41 decreases as shown in FIG. 7B, and the pressure that acts on the incompressible fluid 29 that is sealed increases. Then, the elastic member 23A and the elastic member 23B bulge and deform upward in a convex manner. Conversely, when the energization of to the shape memory alloy coil spring 42 is stopped, it is cooled to return to a low-temperature state (room temperature state), whereupon the shape memory alloy coil spring 42 attempts to elongate and the dimension in the length direction becomes longer. As a result, as shown in FIG. 7A, the torsional deformation that was produced in the variable pressure member 41 is restored. Moreover, due to the resilience force of the return spring 43, the shape memory alloy coil spring 42 and the variable pressure member 41 are reverted to their original shapes.

With this kind of constitution, in the same manner as the tablet device 10 in the aforementioned first exemplary embodiment, by detecting the position of the pen tip of the stylus pen and driving the variable pressure member 41, the elastic members 23A and 23B are in turn made to deform upward in a convex manner in accordance with the position and movement direction of the stylus pen, whereupon it is possible to provide a friction feeling and resistance feeling to the pen tip.

In FIG. 7A and FIG. 7B, as the shape of the variable pressure member 41, a structure is shown having a flange. However, the variable pressure member 41 may have a cylindrical shape with no flange.

### Fourth Exemplary Embodiment

The point of difference between the fourth exemplary embodiment, and the first exemplary embodiment and the second exemplary embodiment shall be described. As with the third exemplary embodiment, the fourth exemplary embodiment differs from the first and second exemplary embodiments in relation to the method of varying pressure by the actuator to the incompressible fluid that has been sealed.

Next, the point of difference between the fourth exemplary embodiment and the third exemplary embodiment shall be described. In the third exemplary embodiment, the shape memory alloy coil spring 42 that elongates or contracts due to heat is wound in a spiral shape on the outer wall surface of the variable pressure member 41, and the return spring 43 that causes the shape memory alloy coil spring 42 and the variable pressure means 41 to revert to their original shapes, in the case of the shape memory alloy coil spring 42 not having an elongation force or contraction force due to heat, is fixed to the inner wall surface of the variable pressure member 41. In contrast to this constitution, in the fourth exemplary embodiment, shape memory alloy coil springs (spiral shape memory alloy springs) 52 and 53 that elongate or contract due to heat are wound in a spiral shape on both the outer wall surface and the inner wall surface of a variable pressure member (hollow cylindrical member) 51.

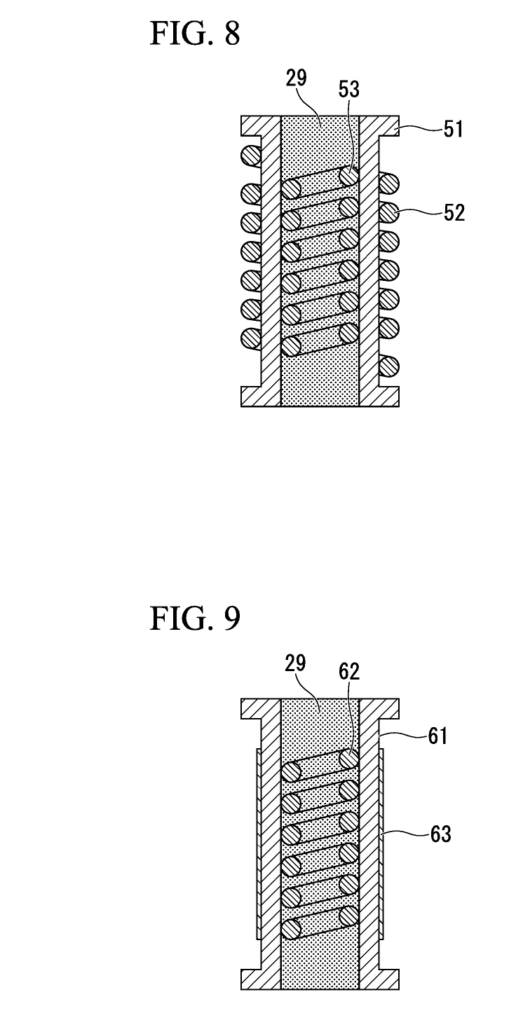

In each space that is partitioned by the housing 21 and the partition walls 22, a cylindrical variable pressure member 51 as shown in FIG. 8 is arranged. The shape memory alloy coil spring 52 that elongates or contracts due to heat is provided on the outer wall surface of the variable pressure member 51. On the inner wall surface of the variable pressure member 51, the shape memory alloy coil spring 53 that elongates or contracts due to heat is constrained to the inner wall surface of the variable pressure member 51 in the state of being inserted in the variable pressure member 51.

A terminal (not illustrated) is provided at both ends of the shape memory alloy coil springs 52 and 53, and constituted so as to be able to apply a voltage.

The incompressible fluid 29 or a gel is sealed in the interior of the variable pressure member 51 with a hollow shape.

For the shape memory alloy coil springs 52 and 53, it is possible to use a material (for example, a Ti—Ni type shape memory alloy) having a characteristic of contracting when the temperature rises and elongating when the temperature decreases.

In this kind of constitution, when electrical current is passed to the shape memory alloy coil springs 52 and 53 via the terminals provided at both ends, they are heated to a high-temperature state and attempt to contract, whereupon their dimensions in the length dimension shorten. As a result, the shape memory alloy coil springs 52 and 53 produce torsional deformation in the variable pressure member 51. At this time, the cross-sectional area of the hollow portion of the variable pressure member 51 decreases, the pressure that acts on the incompressible fluid 29 that is sealed increases, and the elastic member 23A and the elastic member 23B bulge and deform upward in a convex manner.

Conversely, when the energization of the shape memory alloy coil springs 52 and 53 is stopped, they are cooled to return to a low-temperature state (room temperature state), whereupon the shape memory alloy coil springs 52 and 53 attempt to elongate and their dimensions in the length direction become longer. As a result, the torsional deformation that was produced in the variable pressure member 51 is restored.

In the present exemplary embodiment as given above, by detecting the position of the pen tip of the stylus pen and driving the variable pressure member 51, the elastic members 23A and 23B are in turn made to deform upward in a convex manner in accordance with the position and movement direction of the stylus pen. With this constitution, it is possible to provide a friction feeling and resistance feeling to the pen tip.

### Fifth Exemplary Embodiment

In the fifth exemplary embodiment, as shown in FIG. 9, a cylindrical variable pressure member (hollow cylindrical member) 61 is placed in each space that is partitioned by the housing 21 and the partition walls 22.

A shape memory alloy coil spring (spiral shape memory alloy spring) 62 that elongates or contracts due to heat is provided at the inner wall surface of the variable pressure member 61. On the outer wall surface of the variable pressure member 61 is provided a return spring (cylindrical spring) 63 that attempts to revert the shape memory alloy coil spring 62 and the variable pressure member 61 to their original shapes when the shape memory alloy coil spring 62 does not possess an elongation force or a contraction force due to heat.

The incompressible fluid 29 is sealed in the interior of the variable pressure member 61 with a hollow shape.

A terminal (not illustrated) is provided at both ends of the shape memory alloy coil spring 62, and constituted so as to be able to apply a voltage. For the shape memory alloy coil spring 62, a material (for example, a Ti—Ni type shape memory alloy) having a characteristic of for example contracting when the temperature rises and elongating when the temperature decreases may be used.

In this kind of constitution, when electrical current is passed to the shape memory alloy coil spring 62 via the terminal provided at both ends, it is heated to a high-temperature state and attempts to contract, whereupon the dimension in the length dimension shortens. For this reason, torsional deformation is produced in the variable pressure member 61. At this time, similarly to the third exemplary embodiment shown in FIG. 7B, the cross-sectional area of the hollow portion of the variable pressure member 61 decreases, and the pressure that acts on the incompressible fluid 29 that is sealed increases. As a result, the elastic member 23A and the elastic member 23B bulge and deform upward in a convex manner.

Conversely, when the energization of the shape memory alloy coil spring 62 is stopped, it is cooled to return to a low-temperature state (room temperature state), whereupon the shape memory alloy coil spring 62 attempts to elongate and the dimension in the length direction becomes longer. For this reason, the torsional deformation that was produced in the variable pressure member 61 is restored.

In the present exemplary embodiment, by detecting the position of the pen tip of the stylus pen and driving the variable pressure member 61, the elastic members 23A and 23B are in turn made to deform upward in a convex manner in accordance with the position and movement direction of the stylus pen. With this constitution, it is possible to provide a friction feeling and resistance feeling to the pen tip.

The above explanation describes that it is possible to provide a friction feeling and a resistance feeling to the pen tip in the case of the elastic member 23A and the elastic member 23B deforming upward in a convex manner. However, it is also possible to provide a friction feeling and a resistance feeling to the pen tip even in the case of the elastic member 23A and the elastic member 23B deforming downward in a convex manner.

### Sixth Exemplary Embodiment

The point of difference between the sixth exemplary embodiment, and the first exemplary embodiment and the second exemplary embodiment shall be described. The sixth exemplary embodiment differs from the first exemplary embodiment and the second exemplary embodiment on the point of providing a graphic to the pen tip of the stylus pen.

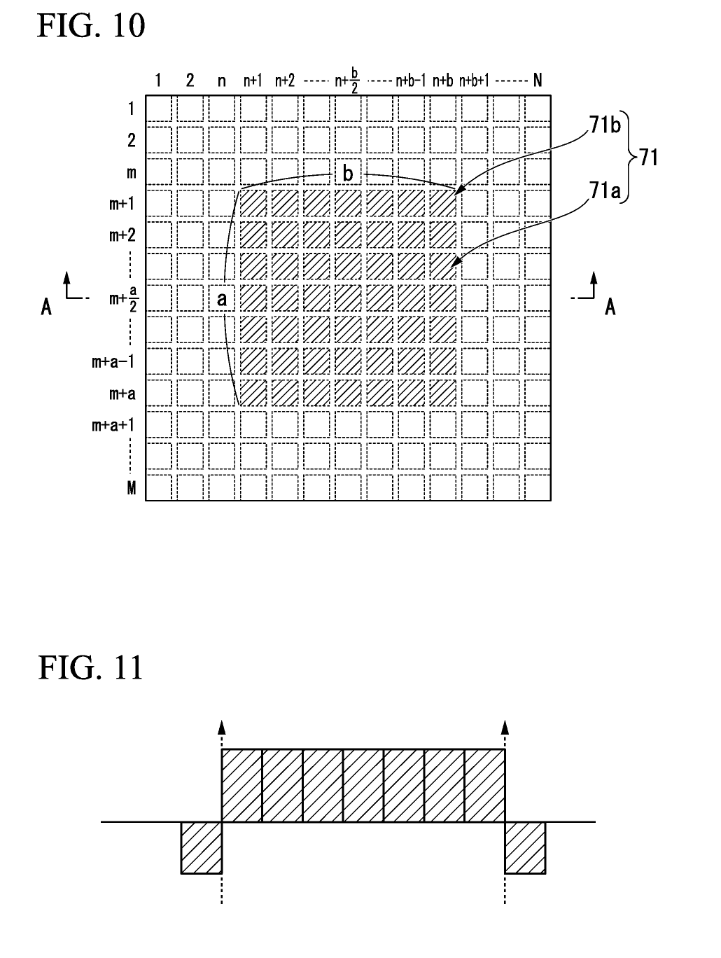

For example, as shown in FIG. 10, in the tablet device 10, there are arranged M in the vertical and N in the horizontal of the spaces which are formed by the housing 21 being partitioned by the partition walls 22. In these partitioned spaces, a quadrilateral 71 of a length in the vertical direction of “a” and a length in the horizontal direction of “b” is shown. Hereinbelow, the method of presenting this quadrilateral 71 shall be described.

First, as shown in FIG. 11, with regard to rightward direction (horizontal direction), a voltage is applied to the actuators 26 and 32 that are in the spaces of row (m+1) column n to row (m+a) column n, to cause the elastic member 23A and the elastic member 23B to deform downward in a convex shape. Also, a voltage of the opposite polarity of the actuators 26 and 32 that are in the spaces of row (m+1) column n to row (m+a) column n is applied to the actuators 26 and 32 that are in the spaces of row (m+1) column (n+1) to row (m+a) column (n+1), to cause the elastic member 23A and the elastic member 23B to deform upward in a convex shape.

Similarly, a voltage is applied to the actuators 26 and 32 that are in the spaces of row (m+1) column (n+b+1) to row (m+a) column (n+b+1), to cause the elastic member 23A and the elastic member 23B to deform downward in a convex shape. Also, a voltage of the opposite polarity of the actuators 26 and 32 that are in the spaces of row (m+1) column (n+b+1) to row (m+a) column (n+b+1) is applied to the actuators 26 and 32 that are in the spaces of row (m+1) column (n+b) to row (m+a) column (n+b), to cause the elastic member 23A and the elastic member 23B to deform upward in a convex shape.

Next, with regard to the downward direction (vertical direction), in the same manner as the rightward direction, a voltage is applied to the actuators 26 and 32 that are in the spaces of row m column (n+1) to row m column (n+b), to cause the elastic member 23A and the elastic member 23B to deform downward in a convex shape. Also, a voltage of the opposite polarity of the actuators 26 and 32 that are in the spaces of row m column (n+1) to row m column (n+b) is applied to the actuators 26 and 32 that are in the spaces of row (m+1) column (n+1) to row (m+1) column (n+b), to cause the elastic member 23A and the elastic member 23B to deform upward in a convex shape.

Similarly, a voltage is applied to the actuators 26 and 32 that are in the spaces of row (m+a+1) column (n+1) to row (m+a+1) column (n+b), to cause the elastic member 23A and the elastic member 23B to deform downward in a convex shape. Also, a voltage of the opposite polarity of the actuators 26 and 32 that are in the spaces of row (m+a+1) column (n+1) to row (m+a+1) column (n+b) is applied to the actuators 26 and 32 that are in the spaces of row (m+a) column (n+1) to row (m+a) column (n+b), to cause the elastic member 23A and the elastic member 23B to deform upward in a convex shape.

For the spaces to the inside of the edge 71a of the quadrilateral 71, that is to say, from the spaces of “row (m+1) column (n+1) to row (m+1) column (n+b)” to the spaces of “row (m+a) column (n+1) to row (m+a) column (n+b)”, a voltage that is applied to the actuators 26 and 32 in all of the spaces is controlled by the controller 2 to deform the elastic member 23A and the elastic member 23B upward in a convex shape.

A voltage is applied to the actuators 26 and 32 in the four spaces of row m column n, row m column (n+b+1), row (m+a+1) column n, and row (m+a+1) column (n+b+1) corresponding to the outer side of the corners 71b of the quadrilateral 71, to cause the elastic member 23A and the elastic member 23B to deform downward in a convex shape.

In this way, a voltage is applied to the actuators 26 and 32 so that the elastic member 23A and the elastic member 23B of the inner side sandwiched between the edges 71a of the quadrilateral 71 deform upward in a convex manner, and a voltage is applied to the actuators 26 and 32 so that the elastic member 23A and the elastic member 23B of the outer side of the edges 71a deform downward in a convex manner. As a result, since the edges 71a are emphasized, perception by tactile sense becomes easy.

In the present exemplary embodiment described above, by detecting the position of the pen tip of the stylus pen and driving the actuators 26 and 32, it is possible to cause the elastic members 23A and 23B to in turn deform upward and downward in a convex shape in accordance with the position and movement direction of the stylus pen, to provide by tactile sense a friction feeling and resistance feeling to the pen tip. Also, during the presentation, for example it is easy for visually impaired people to recognize a graphic.

It is possible to freely control the ratio of the voltages to be applied to both sides facing the edge 71a by the controller 2. The voltage ratio can be set so as to obtain an arbitrary tactile sense.

A description has been given above for the case of the presentation of the quadrilateral 71, but it is not limited thereto. For example, it is also possible to present a polygon such as a triangle or the like by a similar method.

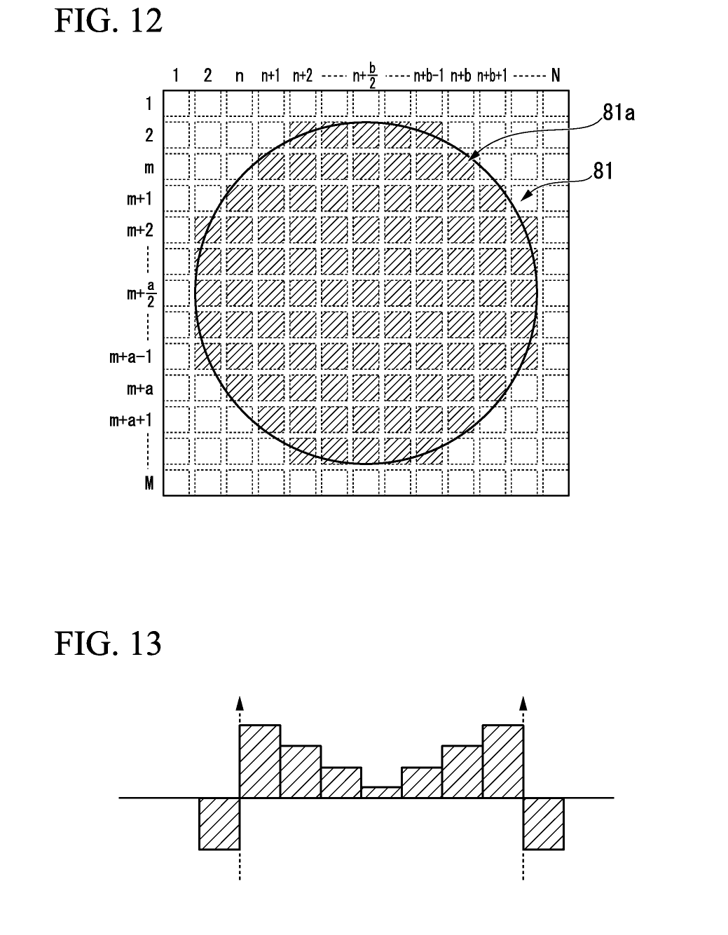

It is also possible to present a graphic that is constituted by for example a curved line, such as a circle 81 shown in FIG. 12. That is to say, a voltage is applied to the actuators 26 and 32 that are to the inside of the edge 81a constituted by a quasi-curved line, to cause the elastic member 23A and the elastic member 23B deform upward in a convex manner. Also, a voltage of the opposite polarity to the actuators 26 and 32 that are to the inside of the edge 81a is applied to the actuators 26 and 32 that are to the outside of the edge 81a, to cause the elastic member 23A and the elastic member 23B deform downward in a convex manner.

In this way, a voltage is applied to the actuators 26 and 32 so that the elastic member 23A and the elastic member 23B of the inner side facing the edge 81a of the circle 81 deform upward in a convex manner, and a voltage is applied to the actuators 26 and 32 so that the elastic member 23A and the elastic member 23B of the outer side facing the edge 81a of the circle 81 deform downward in a convex manner. As a result, since the edge 81a is emphasized, perception by tactile sense becomes easy.

At this time, it is possible to freely control the ratio of the voltages to be applied to both sides facing the edge 81a by the controller 2. Also, with regard to the presentation of the circle 81 by a quasi-curved line, in the same manner as the case described in the aforementioned sixth exemplary embodiment, voltages applied to the actuators 26 and 32 are controlled by the controller 2, and it is possible to deform the elastic member 23A and the elastic member 23B in an upward direction or a downward direction in a convex manner, and also control the displacement amount.

By controlling the voltage to be applied to the actuators 26 and 32 with the controller 2, the displacement amount may be controlled as shown in FIG. 13.

That is to say, in the rightward direction, the displacement amount of the elastic member 23A and the elastic member 23 B is controlled so as to decrease in stages from the spaces of “row (m+1) column (n+1) to row (m+a) column (n+1)” to the spaces of “row (m+1) column (n+b/2) to row (m+a) column (n+b/2)”. Moreover, the voltage that is applied to the actuators 26 and 32 is controlled by the controller 2 so that the displacement amount of the elastic member 23A and the elastic member 23B increases in stages from the spaces of “row (m+1) column (n+b/2) to row (m+a) column (n+b/2)” to the spaces of “row (m+1) column (n+b) to row (m+a) column (n+b)”.

In the downward direction, similarly to the rightward direction, the deformation amount of the elastic member 23A and the elastic member 23 B is controlled so as to decrease in stages from the spaces of “row (m+1) column (n+1) to row (m+1) column (n+b)” to the spaces of “row (m+a/2) column (n+1) to row (m+a/2) column (n+b)”. Moreover, the voltage that is applied to the actuators 26 and 32 is controlled by the controller 2 so that the deformation amount of the elastic member 23A and the elastic member 23B increases in stages from the spaces of “row (m+a/2) column (n+1) to row (m+a/2) column (n+b)” to the spaces of “row (m+a) column (n+1) to row (m+a) column (n+b)”.

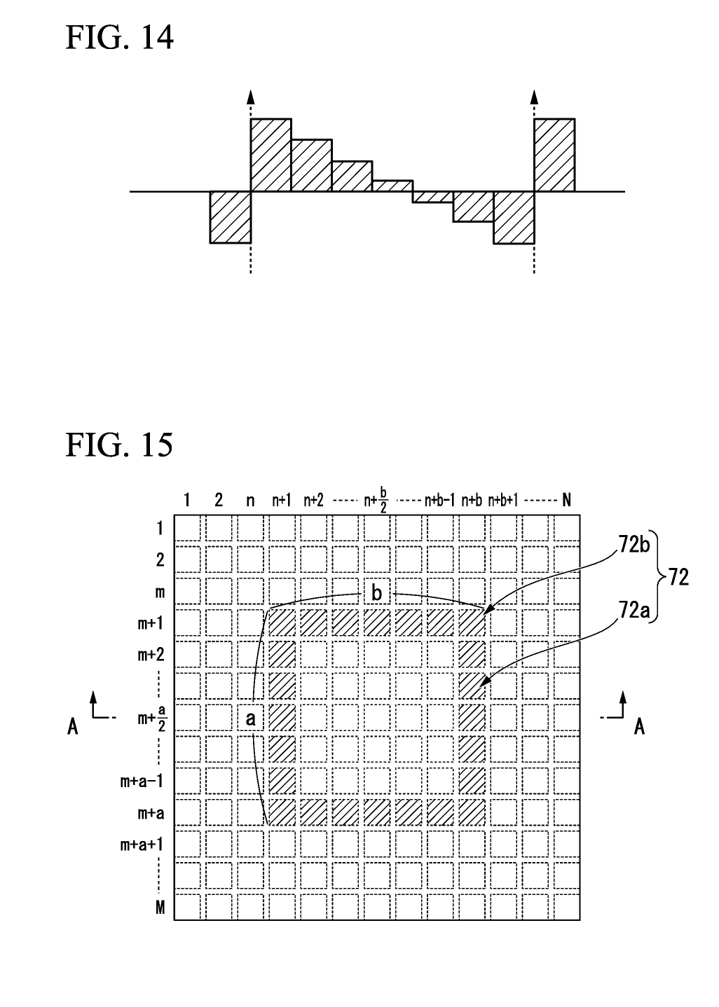

By controlling the voltage to be applied to the actuators 26 and 32 with the controller 2, the displacement amount may be controlled as shown in FIG. 14.

That is to say, in the rightward direction, the voltage that is applied to the actuators 26 and 32 is controlled by the controller 2 so that the displacement amount of the elastic member 23A and the elastic member 23B decreases in stages in one direction from the spaces of “row (m+1) column (n+1) to row (m+a) column (n+1)” to the spaces of “row (m+1) column (n+b) to row (m+a) column (n+b)”.

In the downward direction, similarly to the rightward direction, the voltage that is applied to the actuators 26 and 32 is controlled by the controller 2 so that the displacement amount of the elastic member 23A and the elastic member 23B decreases in stages in one direction from the spaces of “row (m+1) column (n+1) to row (m+1) column (n+b)” to the spaces of “row (m+a) column (n+1) to row (m+a) column (n+b)”.

### Seventh Exemplary Embodiment

The point of difference between the seventh exemplary embodiment, and the first exemplary embodiment and the second exemplary embodiment shall be described. The seventh exemplary embodiment differs from the first and second exemplary embodiments on the point of presenting the graphic to the pen tip of the stylus pen.

Next, the point of difference between the seventh exemplary embodiment and the sixth exemplary embodiment shall be described. The seventh exemplary embodiment differs from the sixth exemplary embodiment in terms of the method of displaying a graphic, that is to say, the method of controlling the voltage to be applied to the actuators 26 and 32 in the spaces.

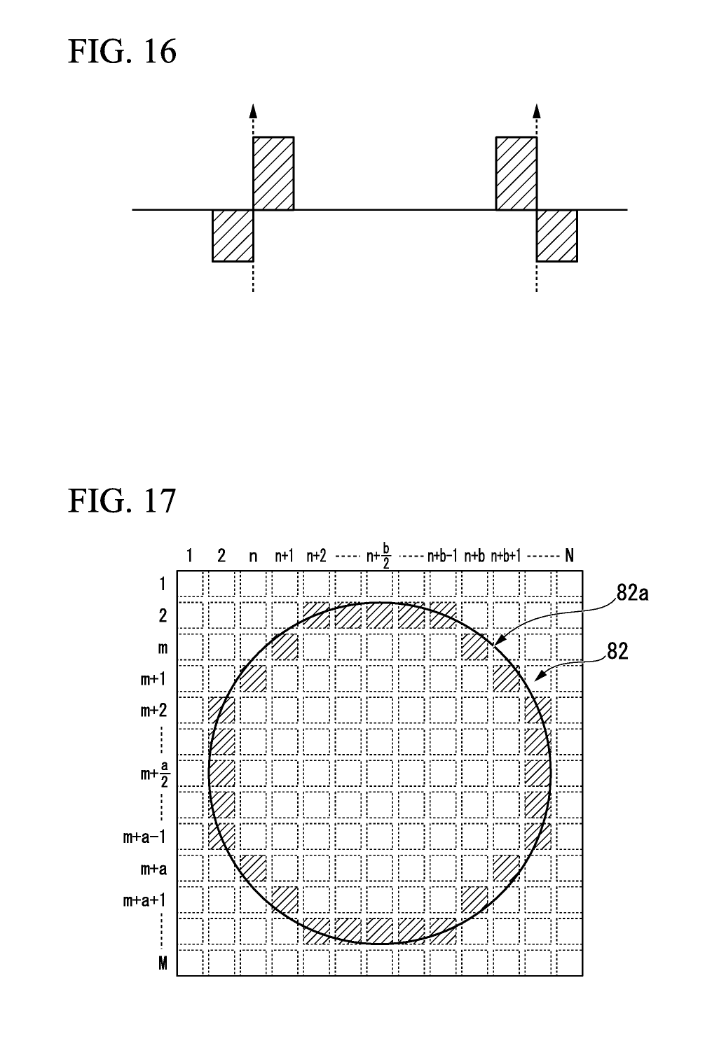

In the sixth exemplary embodiment, the case of the elastic member 23A and the elastic member 23B of the inner side of the graphic facing the edge 71a being entirely displaced is shown. In contrast, in the seventh exemplary embodiment, as shown in FIG. 15 and FIG. 16, voltages are applied only to the actuators of the spaces on both sides sandwiching the edge 72a therebetween, to displace the elastic member 23A and the elastic member 23B. Hereinbelow, the method of presenting the quadrilateral 72 shall be described.

In the rightward direction, a voltage is applied to the actuators 26 and 32 that are in the spaces of “row (m+1) column n to row (m+a) column n” and “row (m+1) column (n+b+1) to row (m+a) column (n+b+1)” to cause the elastic member 23A and the elastic member 23B to deform downward in a convex shape. Also, a voltage of the opposite polarity to the actuators 26 and 32 in the spaces of “row (m+1) column n to row (m+a) column n” and “row (m+1) column (n+b+1) to row (m+a) column (n+b+1)” is applied to the actuators 26 and 32 in the spaces of “row (m+1) column (n+1) to row (m+a) column (n+1)” and “row (m+1) column (n+b) to row (m+a) column (n+b)” to cause the elastic member 23A and the elastic member 23B to deform upward in a convex shape.

In the downward direction, similarly, a voltage is applied to the actuators 26 and 32 that are in the spaces of “row m column (n+1) to row m column (n+b)” and “row (m+a+1) column (n+1) to row (m+a+1) column (n+b)” to cause the elastic member 23A and the elastic member 23B to deform downward in a convex shape. Also, a voltage of the opposite polarity to the actuators 26 and 32 in the spaces of “row m column (n+1) to row m column (n+b)” and “row (m+a+1) column (n+1) to row (m+a+1) column (n+b)” is applied to the actuators 26 and 32 in the spaces of “row (m+1) column (n+1) to row (m+1) column (n+b)” and “row (m+a) column (n+1) to row (m+a) column (n+b)” to cause the elastic member 23A and the elastic member 23B to deform upward in a convex shape.

In this way, a voltage is applied to the actuators 26 and 32 so that the elastic member 23A and the elastic member 23B of the inner side facing the edge 72a of the quadrilateral 72 deform upward in a convex manner, and a voltage is applied to the actuators 26 and 32 so that the elastic member 23A and the elastic member 23B of the outer side of the edge 72a deform downward in a convex manner. As a result, since the edge 72a is emphasized, perception by tactile sense becomes easy. At this time, it is possible to freely control with the controller 2 the ratio of the voltages applied to both sides sandwiching the edge 72a therebetween.

Moreover, the voltage that is applied to the actuators 26 and 32 is controlled by the controller 2 so that the displacement amount of the elastic member 23A and the elastic member 23B becomes zero in all of the spaces from “row (m+2) column (n+2) to row (m+a−1) column (n+2)” to the spaces of “row (m+2) column (n+b−1) to row (m+a−1) column (n+b−1)”. In addition, a voltage is applied to the actuators 26 and 32 in the four spaces of row m column n, row m column (n+b+1), row (m+a+1) column n, and row (m+a+1) column (n+b+1), which correspond to the outer side of the corners 72b of the quadrilateral 72, so that the elastic member 23A and the elastic member 23B deform downward in a convex manner.

In the present exemplary embodiment as described above, it is possible to present by tactile sense a quadrilateral 72 to a pen tip of a stylus pen in the tablet device 10.

The presentation of the quadrilateral 72 is described above, but it is not limited thereto. For example, it is also possible to present a polygon such as a triangle or the like by a similar method.

It is also possible to present a graphic that is constituted by for example a curved line, such as a circle 82 shown in FIG. 17. That is to say, a voltage is applied to the actuators 26 and 32 that are to the inside of the edge 82a constituted by a quasi-curved line, to deform the elastic member 23A and the elastic member 23B upward in a convex manner. Also, a voltage of the opposite polarity to the actuators 26 and 32 that are to the inside of the edge 82a is applied to the actuators 26 and 32 that are to the outside of the edge 82a, to cause the elastic member 23A and the elastic member 23B to deform downward in a convex manner.

In this way, a voltage is applied to the actuators 26 and 32 so that the elastic member 23A and the elastic member 23B of the inner side facing the edge 82a of the circle 82 deform upward in a convex manner, and a voltage is applied to the actuators 26 and 32 so that the elastic member 23A and the elastic member 23B of the outer side facing the edge 82a deform downward in a convex manner. As a result, since the edge 82a is emphasized, perception by tactile sense becomes easy.

At this time, it is possible to freely control the ratio of the voltages to be applied to both sides sandwiching the edge 82a therebetween by the controller 2. Also, with regard to the inner side of the edge 82a constituted by a quasi-curved line, in a similar manner as the case described in the aforementioned sixth exemplary embodiment, voltages applied to the actuators 26 and 32 are controlled by the controller 2, and it is possible to cause the elastic member 23A and the elastic member 23B to deform in an upward direction or downward direction in a convex manner, and also control the displacement amount.

### Eighth Exemplary Embodiment

The eighth exemplary embodiment shown below differs from the first exemplary embodiment and the second exemplary embodiment in relation to the method of presenting the tactile sense of a friction feeling and resistance feeling to be provided to the pen tip of the stylus pen. Also, the eighth exemplary embodiment differs from the sixth exemplary embodiment and the seventh exemplary embodiment on the point of the information to be presented being a letter or numeral other than a graphic.

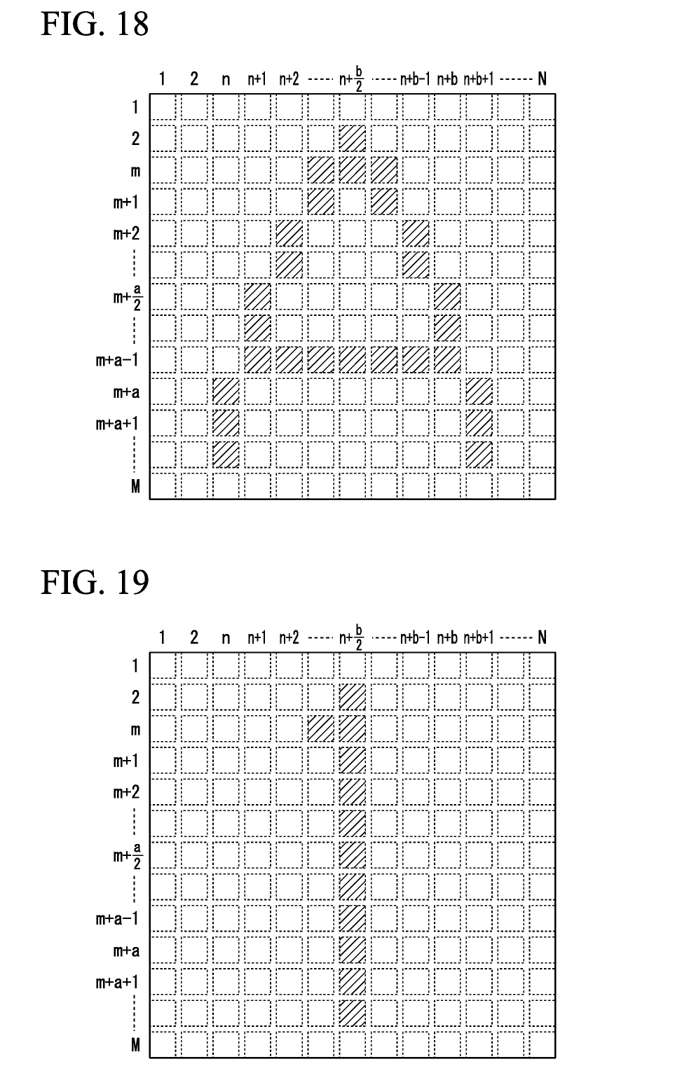

FIG. 18 shows the case of presenting the letter “A” in the tablet device in which M in the vertical and N in the horizontal of spaces, which are formed by the housing 21 being partitioned by the partition walls 22, are arranged. FIG. 19 shows the case of presenting the numeral “1” in the tablet device.

In the case of presenting a letter or numeral, a voltage is applied to the actuators 26 and 32 in the spaces along the straight lines and quasi-curved lines that express the letter and numeral, to deform the elastic member 23A and the elastic member 23B upward in a convex manner. Also, a voltage of the opposite polarity is applied to the actuators 26 and 32 in the spaces on both sides of the aforementioned spaces, to cause the elastic member 23A and the elastic member 23B to deform downward in a convex manner.

By causing them to deform in this way, since the portions that express the letter and numeral are emphasized, perception of the letter and numeral by tactile sense becomes easy. At this time, it is possible to freely control with the controller 2 the ratio of the voltages to be applied to the portions expressing the letter and numeral and to the portions on both sides thereof, and the displacement amount.

In the present exemplary embodiment as given above, it is possible with the tablet device 10 to present by tactile sense a letter and numeral to the pen tip of the stylus pen.

Apart from these, it is possible to selectively choose constitutions given in the aforementioned exemplary embodiments and suitably change them to other constitutions provided the scope of the present invention is not departed from.

In the description given above, a stylus pen is used as the indicator, but it is not limited thereto. It is also possible to use a finger or the like as the indicator.

This application is based upon and claims the benefit of priority from Japanese patent application No. 2011-001821, filed Jan. 7, 2011, and Japanese Patent Application No. 2011-165231, filed Jul. 28, 2011, the disclosure of which is incorporated herein in its entirety by reference.

### INDUSTRIAL APPLICABILITY

The present invention can be applied to a tablet device and a tactile presentation method. This tablet device and tactile presentation method can further improve the operational feeling when performing an input operation by an indicator.

### REFERENCE SYMBOLS

1 Pressing operation unit
2 Controller
10 Tablet device
21 Housing
22 Partition wall
23A, 23B Elastic member
24 Pressure-sensitive sheet
25 Support member
26 Actuator
27 Waterproof sheet
28 Sensor
29 Incompressible fluid
31 Support member
32 Actuator
33 Waterproof sheet
41 Variable pressure member (hollow cylindrical member)
42 Shape memory alloy coil spring (spiral shape memory alloy spring)
43 Return spring (cylindrical spring)
51 Variable pressure member (hollow cylindrical member)
52 Shape memory alloy coil spring (spiral shape memory alloy spring)
53 Shape memory alloy coil spring (spiral shape memory alloy spring)
61 Variable pressure member (hollow cylindrical member)
62 Shape memory alloy coil spring (spiral shape memory alloy spring)
63 Return spring (cylindrical spring)
71 Quadrilateral
71a Edge
71b Corner
72 Quadrilateral
72a Edge
72b Corner
81 Circle
81a Edge
82 Circle
82a Edge

What is claimed is:

1. A tablet device comprising: a pressing operation unit that receives a pressing operation from an indicator; and a controller that detects a pressing position of the indicator with respect to the pressing operation unit, the pressing operation unit comprising:
a housing;
a partition wall that partitions an inner space of the housing into a plurality of spaces;
an elastic sheet that is disposed over an upper portion of the partition wall so as to cover the plurality of spaces partitioned by the partition wall, the elastic sheet elastically deforming in a direction orthogonal to a surface of the elastic sheet;
a pressure-sensitive sheet which is laminated over the elastic sheet, the pressure-sensitive sheet outputting as pressing position information a position pressed by the indicator;
a sensor that is provided over the partition wall, the sensor outputting as indicator position information a position of the indicator over the partition wall upon the indicator being positioned over the partition wall;
an actuator that deforms the elastic sheet; and
an incompressible fluid that is filled in the spaces enclosed by the housing, the partition wall, and the elastic sheet,
the controller controlling actuation of the actuator based on the pressing position information and the indicator position information.

2. The tablet device according to claim 1, wherein
the actuator is provided in each of the plurality of spaces, and
the controller has in advance sensor position information that is position information of the sensor, the controller detects a travelling direction of the indicator based on the pressing position information, the sensor position information, and the indicator position information, and the controller actuates the actuator of the space that is ahead in the detected travelling direction.

3. The tablet device according to claim 2, wherein the controller further detects a movement direction of the indicator based on the pressing position information, the indicator position information, and the sensor position information.

4. The tablet device according to claim 1, wherein the controller controls a displacement amount of the elastic member by controlling a voltage applied to the actuator.

5. The tablet device according to claim 1, wherein the inner space of the housing is divided into a lattice shape by the partition wall.

6. The tablet device according to claim 1, wherein the actuator is a piezoelectric vibrator, and by applying a voltage to the piezoelectric vibrator by the controller, a side wall of the piezoelectric vibrator flexes in a normal direction of a fixed surface of the piezoelectric vibrator.

7. The tablet device according to claim 6, wherein the pressing operation unit further comprises a support member provided between the piezoelectric vibrator and the partition wall.

8. The tablet device according to claim 6, wherein the pressing operation unit further comprises a waterproof sheet provided on a surface of the piezoelectric vibrator on a side opposite the support member.

9. The tablet device according to claim 1, wherein
the actuator includes: a hollow cylindrical member; and a spiral shape memory alloy spring provided on an inner circumferential surface or an outer circumferential surface of the hollow cylindrical member, and
the controller causes a side wall of the hollow cylindrical member to become depressed a normal direction of the partition wall by applying a voltage to the spiral shape memory alloy spring.

10. The tablet device according to claim 9, wherein the actuator further comprises a hollow cylindrical spring provided on an outer circumferential surface or the inner circumferential surface of the hollow cylindrical member.

11. A tactile presentation method for providing a tactile sense in a pressing operation from an indicator, the method comprising:
preparing a pressing operation unit, the pressing operation unit comprising: a housing; a partition wall partitioning an inner space of the housing into a plurality of spaces; an elastic sheet disposed over an upper portion of the partition wall so as to cover the plurality of spaces partitioned by the partition wall; a sensor provided over the partition wall; an actuator deforming the elastic sheet; and an incompressible fluid filled in the spaces enclosed by the housing, the partition wall, and the elastic sheet;
detecting as pressing position information a position pressed by the indicator from the pressure-sensitive sheet;
detecting from the sensor as indicator position information a position of the indicator over the partition wall upon the indicator being positioned over the partition wall;
finding a movement direction of the indicator from sensor position information being already known position information of the sensor, the pressing position information, and the indicator position information; and
deforming the actuator in accordance with the movement direction of the indicator, causing the elastic sheet to deform in a direction orthogonal to a surface of the elastic sheet.

12. The tactile presentation method according to claim 11, wherein
the elastic sheet that covers the space at the pressing position deforms to one side in a direction orthogonal to a surface of the elastic sheet, and
the elastic sheet that covers the space adjacent to the pressing position deforms to other side in the direction orthogonal to the surface of the elastic sheet.

13. The tactile presentation method according to claim 12, wherein the pressing position shows a graphic.

14. The tactile presentation method according to claim 12, wherein the pressing position shows a letter or a numeral.
